(19) United States
(12) Patent Application Publication
(10) Pub. No.: US 2014/0306912 A1
(43) Pub. Date: Oct. 16, 2014

(54) GRADUATED PALM REJECTION TO IMPROVE TOUCH SENSOR PERFORMANCE

(71) Applicant: CIRQUE CORPORATION, Salt Lake City, UT (US)

(72) Inventor: Richard D. Woolley, Orem, UT (US)

(73) Assignee: CIRQUE CORPORATION, Salt Lake City, UT (US)

(21) Appl. No.: 14/254,406

(22) Filed: Apr. 16, 2014

Related U.S. Application Data
(60) Provisional application No. 61/812,544, filed on Apr. 16, 2013.

(51) Int. Cl. G06F 3/041

(52) U.S. Cl. CPC G06F 3/041
USPC 345/173

(57) ABSTRACT

A system and method is provided that creates a touch recognition gradient beginning from all outer edges of a touch sensor, and extending inwards towards a designated center area, wherein contact that is nearer an outer edge of the touch sensor is only recognized if it is a relatively small object, and then allowing recognition of progressively larger objects when approaching the center area, thereby rejecting input from a palm or larger area of a finger when contact is made near the outer edge, while accepting larger objects near the center area.

### BACKGROUND OF THE INVENTION

1. Field of the Invention

This invention relates generally to touch sensors. More specifically, the present invention is a method of preventing accidental input on a touch sensor, such as when the palm of a hand accidentally rests on a portion of the touch sensor such as when performing other tasks such as typing on a keyboard.

2. Description of Related Art

It should be understood that use of the term “touch sensor” throughout this document includes any capacitive touch sensor device, including touchpads, touch screens and touch panels, and includes proximity and touch sensing capabilities.

One of the existing touch sensor designs that can be modified to work with the present invention is a touchpad made by CIRQUE® Corporation. Accordingly, it is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention. The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing. Either design will enable the present invention to function.

The underlying technology for the CIRQUE® Corporation touchpad is based on capacitive sensors. However, other touchpad technologies can also be used for the present invention. These other proximity-sensitive and touch-sensitive touchpad technologies include electromagnetic, inductive, pressure sensing, electrostatic, ultrasonic, optical, resistive membrane, semi-conductive membrane or other finger or stylus-responsive technology.

A touch sensor is often placed in locations that make it easy for a user to accidentally brush the palm of a hand or a finger or thumb across a corner of a touch sensor. For example, a touch sensor is often placed in front of a keyboard in a laptop or other portable computing device. When the user is typing or performing some other function, the user may accidentally brush the corner of a hand across the touch sensor. It would be an advantage over the prior art to be able to provide a means for ignoring accidental contact with a touch sensor.

### BRIEF SUMMARY OF THE INVENTION

In a first embodiment of the present invention, a system and method is provided that creates a touch recognition gradient beginning from all outer edges of a touch sensor, and extending inwards towards a designated center area, wherein contact that is nearer an outer edge of the touch sensor is only recognized if it is a relatively small object, and then allowing recognition of progressively larger objects when approaching the center area, thereby rejecting input from a palm or larger area of a finger when contact is made near the outer edge, while accepting larger objects near the center area.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of operation of a first embodiment of a touchpad that is found in the prior art, and which is adaptable for use in the present invention.

FIG. 2 is a top view of a touch sensor that has equally spaced touch recognition gradient zones.

FIG. 3 is a top view of a touch sensor that has equally spaced elliptical touch recognition gradient zones.

FIG. 4 is a top view of a touch sensor that has touch recognition gradient zones that are not evenly spaced.

FIG. 5 is a top view of a touch sensor and touch recognition gradient zones that are not rectangular.

FIG. 6 is a top view of a touch sensor where the touch recognition gradient zones are not spaced evenly and not centered within the touch sensor.

FIG. 7 is a top view of a keyboard having a large touch sensor area in the palm rest of a laptop, and a central area in the touch sensor where large objects may be accepted for touch input.

FIG. 8 is a top view of a touch sensor having only two touch recognition gradient zones.

FIG. 9 is a flowchart of one embodiment of the present invention.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

Using a touch sensor in certain environments can be difficult because of where a touchpad may often be located on or within a computing device. For example, in a laptop or other portable computing device, a touchpad may often be placed in front of a keyboard. When a user is typing, a thumb or a palm of a hand can easily brush against a portion of the touch sensor. This inadvertent contact with the touch sensor can often be misinterpreted as intentional input, causing unintended data input to the portable computing device. Unintended data input may therefore be avoided using a first embodiment of the present invention.

There are times when part of a palm or hand that is making contact with a touch sensor may appear as a finger, thus potentially providing inaccurate input to the touch sensor. Much information may be gathered from the touch sensor that may also be used to try and determine if the object making contact is desirable finger or stylus input or an unwanted hand or palm. It may be particularly challenging to determine whether input near or at the outer edges of the touch sensor is finger input or palm input because the object at the outer edge may only be a partial object.

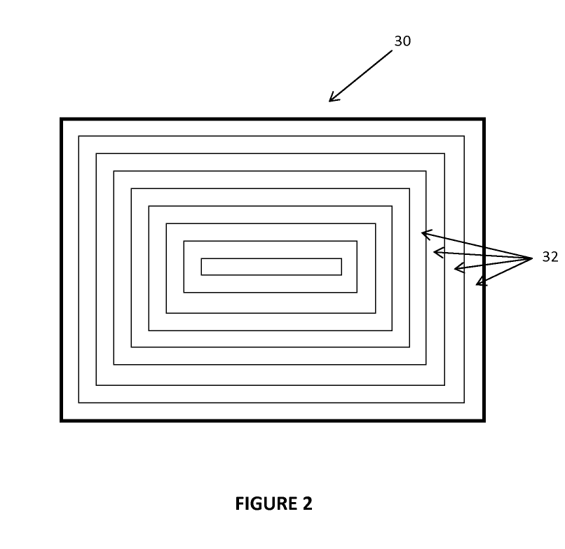

Therefore, even large objects that make contact near the edge of a touch sensor may appear to be relatively small, or similar to a finger in size. Therefore, the first embodiment may use a touch recognition gradient to determine if an object should be recognized as a valid touch. FIG. 2 is a top view of a touch sensor 30. The touch sensor may be configured such that only relatively small objects of a defined size, or only objects up to a certain size, are recognized near the outer edge of the touch sensor 30. One method of implementing a touch recognition gradient may be to consider the touch sensor as being comprised of a plurality of touch recognition gradient zones 32 that allow progressively larger objects to be recognized as valid touch input. FIG. 2 shows a gradient having touch recognition gradient zones 32 that may be evenly spaced apart.

The touch sensor of FIG. 2 is also shown with a plurality of progressively smaller rectangular touch recognition gradient zones 32. It should be understood that the size, shape and number of the touch recognition gradient zones 32 should not be considered as limiting the concept of the first embodiment. The size, shape and number of the different touch recognition gradient zones 32 may be different, and still be considered as falling within the scope of the present invention. Thus, the touch recognition gradient zones 32 may not be rectangular, but may be any shape, including irregular and curvilinear shapes.

The embodiments of the present invention include touch recognition gradient zones that are surrounded by a largest touch recognition gradient zone which surrounds a next largest touch recognition gradient zone and proceeding all the way to the smallest touch recognition gradient zone. The touch recognition gradient zones may all be centered on an approximate center of the touch sensor, or they may be offset from the approximate center. The distance between each of the touch recognition gradient zone may be equidistant, progress from a largest spacing to a smallest spacing, or from a smallest spacing to a largest spacing when moving from an outer perimeter of the touch sensor to an approximate center. The touch recognition gradient zones may have a same shape or outline as an outer perimeter of the touch sensor or the touch recognition gradient zones may have a different shape.

It should be understood that not all of the touch recognition gradient zones 32 may be identified in each figure throughout this document, but a few may be selected to show their general locations.

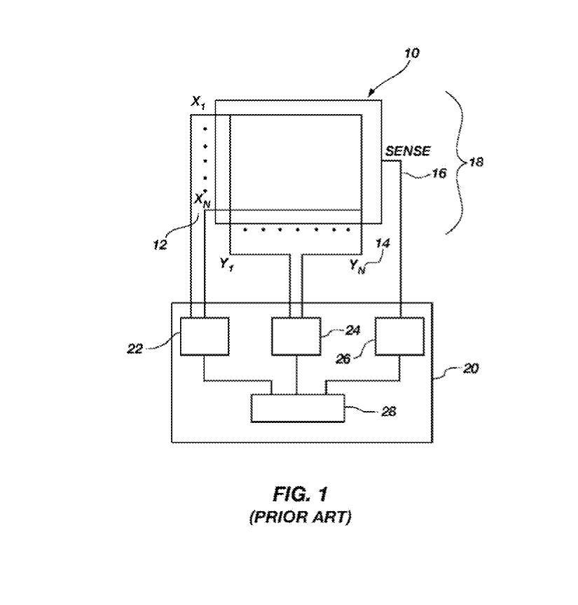

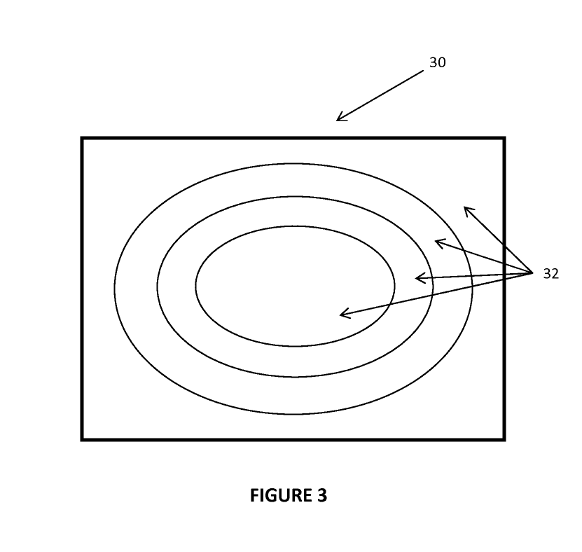

FIG. 3 is a top down view of the touch sensor 30 but having touch recognition gradient zones 32 that are elliptical in shape, and fewer touch recognition gradient zones than in FIG. 1.

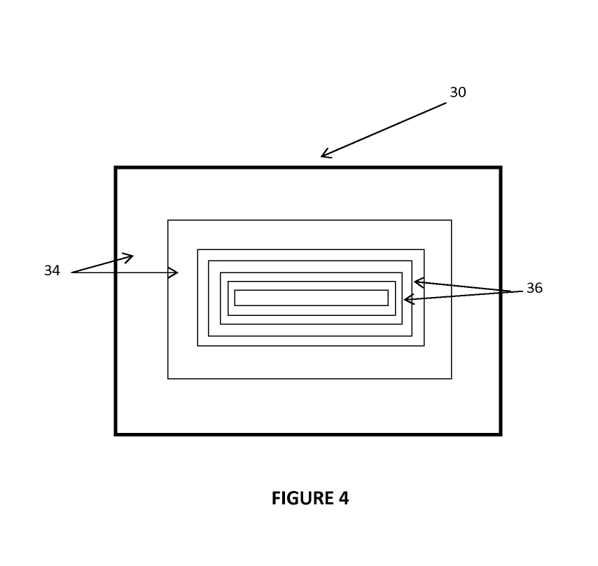

FIG. 4 shows another embodiment of the touch sensor 30 wherein the outer touch recognition gradient zones 34 may be larger and the inner touch recognition gradient zones 36 may be closer together. In this embodiment, the inner portion of the touch sensor 30 rapidly increases the size of the object that may be considered as valid touch input, while the outer touch recognition gradient zones 34 increase the area of the touch sensor that only accepts relatively smaller objects as valid input. This is demonstrated in FIG. 4 where there are fewer outer touch recognition gradient zones 34 which are farther apart, and more inner touch recognition gradient zones 36 that are closer together.

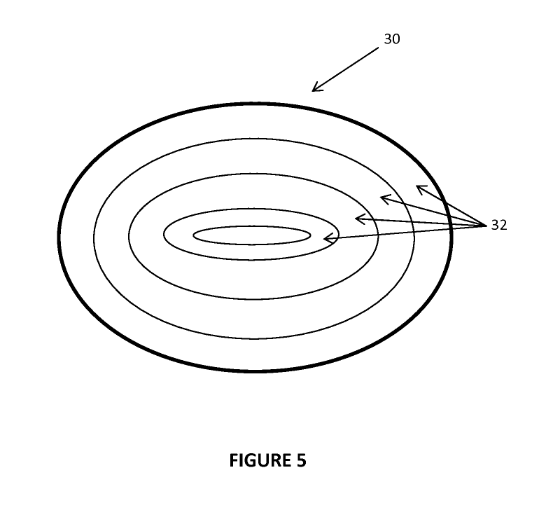

FIG. 5 is a top view of another embodiment of the present invention, where the outer shape of the touch sensor 30 may be elliptical, and the plurality of touch recognition gradient zones 32 become smaller and smaller.

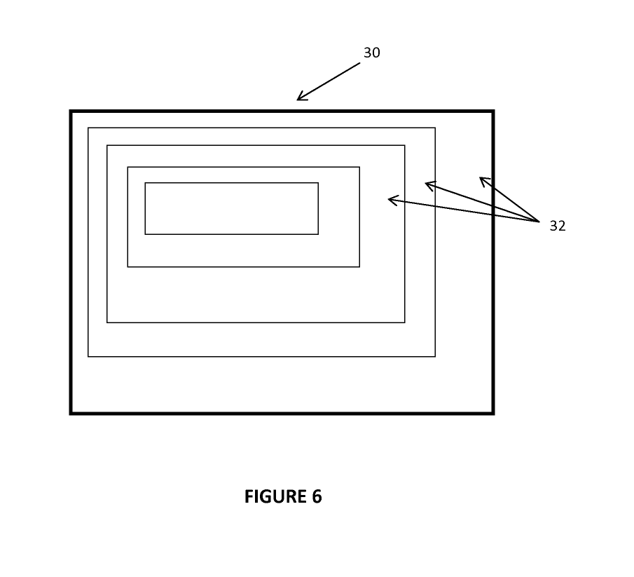

FIG. 6 is a top view of another embodiment of the present invention, where the outer shape of the touch sensor 30 is not important. What may be unique to this embodiment is that the plurality of touch recognition gradient zones 32 are no longer centered, but are now off-center as they become smaller.

Regarding the reduction in size of objects that are recognized by the touch recognition gradient zones, any appropriate dimension may be used. For example, the largest object that may be detectable near the outer edge of the touch sensor may have an upper limit of 5 to 10 mm. Depending on the number of touch recognition gradient zones, the size of the object that is recognized as valid input may grow at any desired rate. Furthermore, the rate of growth of the object that may be recognized as valid input does not have to be linear.

An example of a linear rate of growth might be as follows. The outer touch recognition gradient zone might only recognize objects that are 10 mm or smaller, the next zone may recognize objects that are 12 mm or smaller, continuing to increase 2 mm per touch recognition gradient zone until reaching a center zone.

An example of a non-linear rate of growth may be as follows. The outer touch recognition gradient zone might only recognize objects that are 10 mm or smaller, the next zone might recognize objects that are 12 mm or smaller, the next zone may be 15 mm or smaller, then 20 mm or smaller, etc. What is important to recognize is that the spacing of the touch recognition gradient zones might be linear or non-linear, and the increase in size of objects recognized as valid may be linear or non-linear. It should be understood that the dimensions given are for illustration purposes only and may be changed without limiting the scope of the present invention.

In another embodiment of the invention, while touchdown of an object may be controlled as described in the embodiments above, once the object is recognized as valid, it may move anywhere on the touch sensor 30 and may still be recognized as valid regardless of the size of object that is recognized in any of the touch recognition gradient zones. The previous embodiments are for recognition of the object at touchdown on the surface of the touch sensor. Once the object is recognized as valid, movement to any other touch recognition gradient zone may not be restricted.

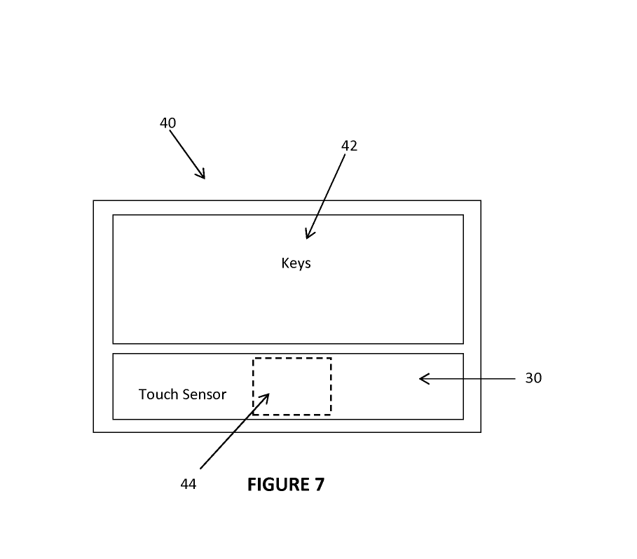

In another alternative embodiment, FIG. 7 is a top view of a keyboard 40 having a plurality of keys 42 and touch sensor 30. The keyboard 40 may be disposed within a laptop computer or it could be a standalone device that is plugged in to a desktop computer. In this embodiment, the touch sensor may be made considerably larger than a typical touch sensor. For example, consider a palm rest area of a keyboard 40 that may be installed in a laptop computer. The touch sensor 30 may occupy the majority of the area that may usually designated as a palm rest. The user may typically rest the palms of the hands in this area. The present invention may be used to enable the touch sensor to ignore the palms or the thumbs of the hands as they rest on the touch sensor 30 when typing. In this embodiment, large objects may be accepted as input only in a central area 44 of the touch sensor 30 and rejected on a gradient scale the further an object is located from the central area. Therefore, the entire touch sensor 30 may be active for typical cursor control by a finger, but all large objects are ignored outside of the central area 44.

In another alternative embodiment of the present invention, certain gestures may be able to be recognized as valid based on where the gesture is performed. Cursor motion, gesture input, and tapping gestures may all be limited this way.

For example, consider a tapping gesture. All tapping gestures may be ignored when they take place near the outer edge of the touch sensor. For a tapping gesture to be recognized as valid, it may have to be executed within a certain distance of the center zone of the touch sensor 30. For example, no tapping may be recognized as valid that is greater than 50% of the distance from a center area of the touch sensor 30 toward an outer edge.

In another alternative embodiment, limits on recognition of a valid touch might be adjusted based on other activities. For example, if typing activity is detected, input from the touch sensor might become more restrictive, but become less restrictive when no typing activity has occurred for some period of time. Thus, a timer might also be used that may affect limits on touch sensor input.

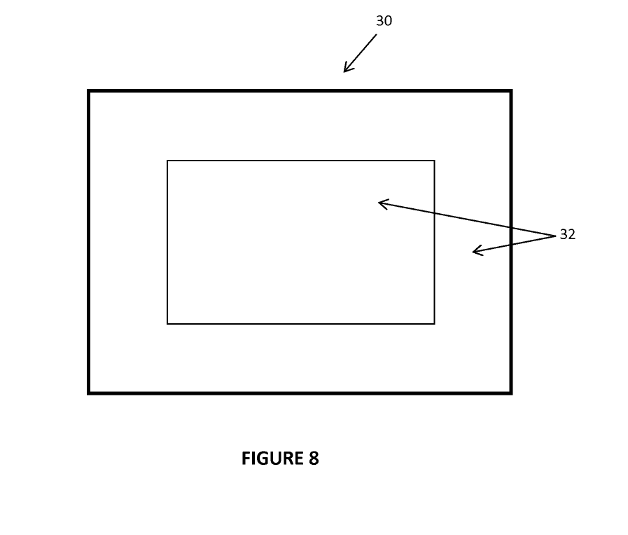

FIG. 8 is another alternative embodiment of the invention. In this top down view, the touch sensor 30 includes only two touch recognition gradient zones 32. The exact size of the touch recognition gradient zones 32 may be adjusted as needed. Furthermore, the size may even be adjustable, for example, in a control panel to provide more user customization of the touch sensor 30.

While the embodiments of the present invention may be directed to rejecting a touch based only on the size of the object detected and in which touch recognition gradient zone the touch occurs, there may be other criteria used to reject a touch. For example, if the touch sensor has corners, any touch within a certain distance of a corner may be rejected because the size of the object is unknown. Another criteria that may be used is to reject all touches that occur within a certain distance of an edge. Another criteria that may be used is to reject a touch that is created by objects having a specific shape. For example, all touches that are elongated or crescent shapes tend to be accidental contacts, so they may always be rejected.

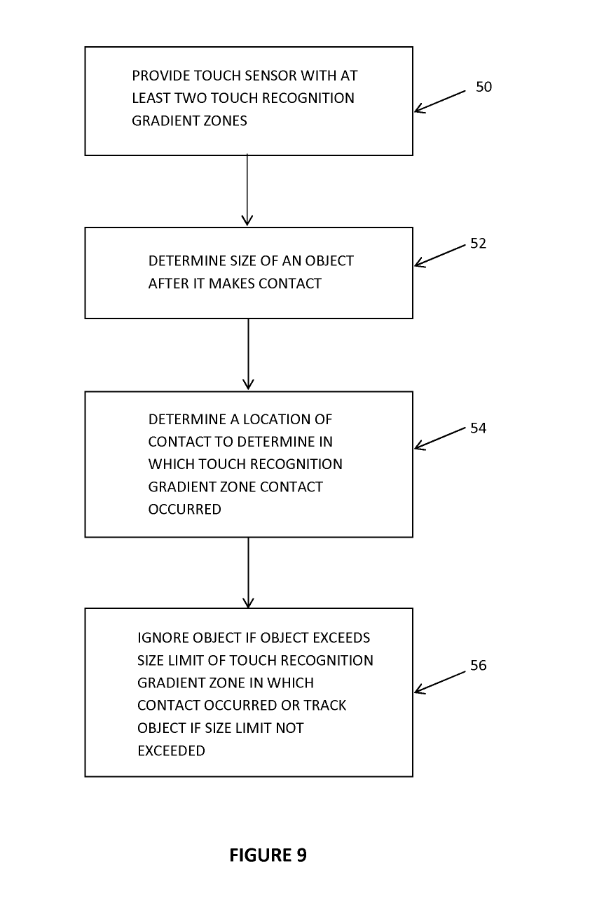

The method of one embodiment of the present invention may be as follows as shown in FIG. 9. The first step 50 is to provide a touch sensor that has at least two touch recognition gradient zones. There may be many touch recognition gradient zones, but the method will work with at least two.

The next steps 52, 54 are to determine a size of an object when it makes contact with the touch sensor and to determine a location of contact of the object on the touch sensor. These two steps may be performed in any order relative to each other. The step of determining a location is for the purpose of determining in which touch recognition gradient zone the contact has occurred. The step of determining the size of the object is used to determine if the object will be recognized or ignored. Thus, once the size of the object is known and the location is known, these two values are used to determine what occurs next. In step 56, if the object exceeds a size limit for the touch recognition gradient zone in which touchdown has occurred, then the object is ignored, which means that it is not tracked. However, if the size of the object is under the size limit for that particular touch recognition gradient zone, then the object is recognized, which means it is tracked.

Recognition and tracking may consist of tracking a gesture being performed such as a tap, a double tap, a drag function, or following movement of an object as a cursor is controlled or other similar actions that may be performed with a mouse or a touch sensor.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for reducing unintended touch input on a touch sensor, said method comprising:
1) providing a touch sensor having at least two touch recognition gradient zones, a largest touch recognition gradient zone completely surrounding a next largest touch recognition gradient zone until a smallest touch recognition gradient zone is reached;
2) determining a size of an object when it makes contact with the touch sensor;
3) determining a location of contact on the touch sensor in order to determine in which of the at least two touch recognition gradient zones the contact has occurred; and
4) ignoring the object and not tracking it if the object exceeds a size limit for the touch recognition gradient zone, or recognizing and tracking the object if the size limit is not exceeded.

2. The method as defined in claim 1 wherein the method of providing the at least two touch recognition gradient zones further comprises providing a plurality of touch recognition gradient zones having a same outline and that are equidistantly spaced from a next largest and next smallest touch recognition gradient zone.

3. The method as defined in claim 1 wherein the method of providing the at least two touch recognition gradient zones further comprises providing a plurality of touch recognition gradient zones having a same outline and that are spaced furthest apart near an outer edge of the touch sensor and becoming progressively closer together proceeding inwards to a smallest touch recognition gradient zone.

4. The method as defined in claim 1 wherein the method of providing the at least two touch recognition gradient zones further comprises providing a plurality of touch recognition gradient zones that have the same shape as an outer perimeter of the touch sensor.

5. The method as defined in claim 1 wherein the method of providing the at least two touch recognition gradient zones further comprises providing a plurality of touch recognition gradient zones that have a different shape as an outer perimeter of the touch sensor.

6. The method as defined in claim 1 wherein the method of providing the at least two touch recognition gradient zones further comprises providing a plurality of touch recognition gradient zones that are not centered on a center of the touch sensor.

7. The method as defined in claim 1 wherein the method of providing the at least two touch recognition gradient zones further comprises providing a plurality of touch recognition gradient zones that are centered on approximately a center of the touch sensor.

8. The method as defined in claim 1 wherein the method further comprises selecting the shape of the at least two touch recognition gradient zones from the group of shapes comprised of rectangles, squares, ellipticals and circles.

9. A method for reducing unintended touch input on a touch sensor, said method comprising:
1) providing a touch sensor having at least two touch recognition gradient zones, a largest touch recognition gradient zone completely surrounding a next largest touch recognition gradient zone until a smallest touch recognition gradient zone is reached;
2) determining a location of contact on the touch sensor in order to determine in which of the at least two touch recognition gradient zones the contact has occurred;
3) determining a size of an object when it makes contact with the touch sensor; and
4) ignoring the object and not tracking it if the object exceeds a size limit for the touch recognition gradient zone, or recognizing and tracking the object if the size limit is not exceeded.

10. The method as defined in claim 9 wherein the method of providing the at least two touch recognition gradient zones further comprises providing a plurality of touch recognition gradient zones having a same outline and that are equidistantly spaced from a next largest and next smallest touch recognition gradient zone.

11. The method as defined in claim 9 wherein the method of providing the at least two touch recognition gradient zones further comprises providing a plurality of touch recognition gradient zones having a same outline and that are spaced furthest apart near an outer edge of the touch sensor and becoming progressively closer together proceeding inwards to a smallest touch recognition gradient zone.

12. The method as defined in claim 9 wherein the method of providing the at least two touch recognition gradient zones further comprises providing a plurality of touch recognition gradient zones that have the same shape as an outer perimeter of the touch sensor.

13. The method as defined in claim 9 wherein the method of providing the at least two touch recognition gradient zones further comprises providing a plurality of touch recognition gradient zones that have a different shape as an outer perimeter of the touch sensor.

14. The method as defined in claim 9 wherein the method of providing the at least two touch recognition gradient zones further comprises providing a plurality of touch recognition gradient zones that are not centered on a center of the touch sensor.

15. The method as defined in claim 9 wherein the method of providing the at least two touch recognition gradient zones further comprises providing a plurality of touch recognition gradient zones that are centered on approximately a center of the touch sensor.

16. The method as defined in claim 9 wherein the method further comprises selecting the shape of the at least two touch recognition gradient zones from the group of shapes comprised of rectangles, squares, ellipticals and circles.
